(19) United States
(12) Patent Application Publication
(10) Pub. No.: US 2009/0085892 A1
(43) Pub. Date: Apr. 2, 2009

(54) INPUT DEVICE USING TOUCH PANEL

(76) Inventors: Kenichiro Ishikura, Tochigi (JP); Seiji Sato, Kyoto (JP); Tomohiko Nishimura, Kyoto (JP); Katsunori Shirai, Nara (JP); Minoru Mayumi, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/280,731

(22) PCT Filed: Feb. 2, 2007
(86) PCT No.: PCT/JP2007/051785

§ 371 Date: Aug. 26, 2008

(30) Foreign Application Priority Data
Mar. 1, 2006 (JP) 2006-054925

(51) Int. Cl. G06F 3/044

(52) U.S. Cl. 345/174

(57) ABSTRACT

There is provided an input device using a touch panel allowing input operations to be performed without viewing an input surface. The input device includes a transparent capacitance-type touch panel (12) formed in the shape of a dome, and a liquid crystal panel (14a) disposed on the back side of the touch panel. The position detection processing portion (20) applies predetermined voltage to four terminals (T1 to T4) of the touch panel, and detects current flowing via each terminal to detect the coordinates of a point on the touch panel operated by the operator's finger (100) based on the detected current value. The data processing portion (30) causes a liquid crystal display device (14) to display an operation screen, including graphics, symbols, etc., which correspond to inputtable operations, based on a status signal Sst from electronic equipment in which the input device is used, and the data processing portion determines the content of an input operation performed by the finger pressing the touch panel, based on a position signal Spos indicating the coordinates of the operation point and the status signal Sst. The present invention is suitable for input devices using a touch panel.

### TECHNICAL FIELD

The present invention relates to input devices for operating electronic equipment or suchlike, and more specifically to an input device using a touch panel.

### BACKGROUND ART

In recent years, the touch panel has been used in input devices for operating various electronic equipment or suchlike. In such an input device, when the operator touches (or presses) an input surface of the touch panel with his/her finger, or a predetermined pen or suchlike, the coordinates of the touched or pressed point (hereinafter, referred to as the “operation point”) on the input surface are detected to output a signal indicating that an operation inputtable via the touch panel and previously correlated with the coordinates (the operation point) has been performed. Accordingly, the input device needs to be configured in such a manner as to allow the operator to recognize which position on the input surface should be selected as the operation point in order to perform a desired operation. Therefore, a display portion is normally disposed on the back side of a transparent touch panel in order to display graphics, symbols, etc., which correspond to their respective inputtable operations.

The input device using the touch panel is advantageous in its user-friendliness, allowing the operator to directly operate the transparent input surface covering the display surface, while viewing the display surface presenting the graphics, symbols, etc., which represent buttons or suchlike corresponding to their respective inputtable operations. In addition, by configuring the input device such that a display on the input surface, i.e., an operation screen, can be switched in accordance with various functions of the electronic equipment in which the input device is used, it becomes possible to allow operations correlated with a number of functions to concentrate on one input surface.

Technologies relevant to the present invention, regarding such input devices using the touch panel, are described in the following documents. Of the documents, Patent Document 1 discloses a capacitance-type touch panel system, and Patent Documents 2 to 5 disclose a curved touch panel, or a coordinates input device, electro-optical panel or display device in which the curved touch panel is used.

[Patent Document 1] Japanese Examined Patent Publication No. 1-19176

[Patent Document 2] Japanese Laid-Open Patent Publication No. 2001-154592

[patent Document 3] Japanese Laid-Open Patent Publication No. 2002-202855

[Patent Document 4] Japanese Laid-Open Patent Publication No. 2004-94450

[Patent Document 5] Japanese Laid-Open Patent Publication No. 2004-252676

### DISCLOSURE OF THE INVENTION

### Problems to be Solved by the Invention

The input device using the touch panel has the aforementioned advantage because it can be operated while viewing the display on the input surface, and therefore such an input device is widely used as an input operation means for various equipment such as electronic equipment.

However, when operating electronic equipment or suchlike, in some cases, it is convenient for the operator to be able to perform a desired operation without viewing the input device. An exemplary case is where the driver operates in-car electronic equipment, such as a car navigation system or a car stereo system.

Therefore, an objective of the present invention is to provide an input device using a touch panel allowing input operations to be performed without viewing an input surface.

### Solution to the Problems

A first aspect of the present invention is directed to an input device using a touch panel, including:

a transparent capacitance-type touch panel having a curved input surface; and

a display portion having a display surface disposed on the back side of the touch panel.

In a second aspect of the present invention, based on the first aspect of the invention, the input surface is in the shape of a dome, a bowl, or an arch.

In a third aspect of the present invention, based on the first aspect of the invention, the input surface has a flat member disposed around its periphery.

In a fourth aspect of the present invention, based on the first aspect of the invention, the input surface has a curved member disposed around its periphery, the curved member being differently curved from the input surface.

In a fifth aspect of the present invention, based on the first aspect of the invention, the input surface has a member disposed around its periphery, the member providing a different feel from that provided by the input surface.

In a sixth aspect of the present invention, based on the first aspect of the invention, the display portion variably displays, on the display surface, graphics and/or symbols corresponding to operations that can be inputted via the touch panel.

In a seventh aspect of the present invention, based on the sixth aspect of the invention, the display portion includes a liquid crystal panel for displaying the graphics and/or symbols.

In an eighth aspect of the present invention, based on the sixth aspect of the invention, the input device further includes:

a position detection processing portion for outputting a position signal indicating a position of an operation point selected on the input surface for an input operation via the touch panel; and

an operation detection processing portion for outputting an operation signal indicating the content of the input operation via the touch panel,

wherein the touch panel includes at least three terminals at different positions around its circumference,

wherein the position detection processing portion supplies predetermined voltage to the three terminals, detects current flowing via each terminal, and generates the position signal based on a value of the detected current, and

wherein the operation detection processing portion receives a predetermined status signal, causes the display surface to display the graphics and/or symbols based on the status signal, and generates as the operation signal a signal indicating the content of an operation corresponding to the operation point, based on the position signal and the status signal.

### EFFECT OF THE INVENTION

According to the first aspect of the present invention, the touch panel has a curved input surface, and therefore the operator can find by touch the position within the input surface that corresponds to a desired operation, and press the position with his/her finger or suchlike to perform the operation without viewing the input surface. Therefore, the input device according to the present invention is useful as, for example, an input operation means for in-car electronic equipment. In addition, the touch panel is of a capacitance type, and therefore satisfactory transparency is ensured compared to touch panels of other types even if the touch panel is curved. As a result, when comparing to touch panels of other types, the input surface has attractive appearance, and the content of a display on the display portion is highly recognizable when viewed via the touch panel. Thus, the operator can readily and correctly recognize the position within the input surface that corresponds to each inputtable operation (the position serving as an operation point).

According to the second aspect of the present invention, the touch panel has an input surface in the shape of a dome, a bowl, or an arch, and therefore the operator can correctly find by touch the position within the input surface that corresponds to a desired operation, and presses the position with his/her finger or suchlike to perform the operation without viewing the input surface.

According to the third aspect of the present invention, the input surface of the touch panel has a flat member disposed around its periphery, and therefore the operator can readily recognize by touch the boundary between the area of the input surface and its periphery, and correctly find by touch the position within the input surface that corresponds to a desired operation.

According to the fourth aspect of the present invention, the input surface of the touch panel has a curved member disposed around its periphery, the curved member being differently curved from the input surface, and therefore the operator can readily recognize by touch the boundary between the area of the input surface and its peripheral area, and correctly recognize by touch the position within the input surface that corresponds to a desired operation.

According to the fifth aspect of the present invention, the input surface of the touch panel has a member disposed around its periphery, the member providing a different feel from that provided by the input surface, and therefore the operator can readily recognize by touch the boundary between the area of the input surface and its peripheral area, and correctly find by touch the position within the input surface that corresponds to a desired operation.

According to the sixth aspect of the present invention, an operation screen, including graphics and/or symbols corresponding to inputtable operations, is switched in accordance with a function or mode selected in electronic equipment or suchlike in which the input device is used, and therefore it is possible to allow operations correlated with a plurality of functions or modes of the electronic equipment or suchlike to concentrate on one input surface. In addition, the touch panel is of a capacitance type, which ensures satisfactory transparency even if the touch panel is curved, and therefore it is possible to ensure that the operator can visually recognize inputtable operations and the positions within the input surface that correspond to the operations on each occasion, even if the operation screen is switched in accordance with selection of a function or mode in electronic equipment or suchlike.

According to the seventh aspect of the present invention, an operation screen, including graphics and/or symbols corresponding to inputtable operations, is displayed on the liquid crystal panel, and switched in accordance with a function or mode selected in electronic equipment or suchlike in which the input device is used, and therefore it is possible to allow operations corresponding to a plurality of functions or modes of the electronic equipment or suchlike to concentrate on one input surface. In addition, the liquid crystal panel is used in the display portion, and therefore it is possible to achieve a compact input device allowing operations in various conditions and applications.

According to the eighth aspect of the present invention, based on a status signal from electronic equipment or suchlike in which the input device is used, an operation screen, including graphics and/or symbols corresponding to inputtable operations, is displayed on the display surface on the back side of the touch panel, and based on a position signal that indicates the position of an operation point on the input surface and the status signal, a signal that indicates the content of an operation corresponding to the operation point is outputted as an operation signal. As a result, it is possible to allow operations for various statuses of the electronic equipment or suchlike to concentrate on one input surface. Furthermore, the touch panel is of a capacitance type, which ensures satisfactory transparency even if the touch panel is curved, and therefore it is possible to ensure that the operator can visually recognize inputtable operations and the positions within the input surface that correspond to the operations on each occasion even if the operation screen is switched in accordance with the status of the electronic equipment or suchlike.

### BRIEF DESCRIPTION OF THE DRAWINGS

FIG. 1 is a block diagram schematically illustrating the configuration of an input device according to an embodiment of the present invention.

FIG. 2 is a cross-sectional view illustrating the configuration of a substantial portion of the input device in the embodiment.

FIG. 3A is a diagram illustrating a first exemplary display on an input surface in the embodiment.

FIG. 3B is a diagram illustrating a second exemplary display on the input surface in the embodiment.

FIG. 3C is a diagram illustrating a third exemplary display on the input surface in the embodiment.

FIG. 4 is a cross-sectional view illustrating the configuration of a substantial portion in a first variant of the embodiment.

FIG. 5 is a cross-sectional view illustrating the configuration of a substantial portion in a second variant of the embodiment.

FIG. 6A is a cross-sectional view illustrating a first exemplary configuration in the embodiment for allowing the area of the input surface to be recognized by touch.

FIG. 6B is a cross-sectional view illustrating a second exemplary configuration in the embodiment for allowing the area of the input surface to be recognized by touch.

FIG. 6C is a side view illustrating a third exemplary configuration in the embodiment for allowing the area of the input surface to be recognized by touch.

FIG. 6D is a side view illustrating a fourth exemplary configuration in the embodiment for allowing the area of the input surface to be recognized by touch.

FIG. 7 is a cross-sectional view illustrating the configuration of a substantial portion in a third variant of the embodiment.

FIG. 8 is a perspective view illustrating the configuration of a substantial portion in a fourth variant of the embodiment.

FIG. 9 is a perspective view illustrating the configuration of a substantial portion in a fifth variant of the embodiment.

FIG. 10 is a cross-sectional view illustrating another exemplary configuration of the input surface in the embodiment.

FIG. 11 is a cross-sectional view illustrating still another exemplary configuration of the input surface in the embodiment.

FIG. 12 is a cross-sectional view illustrating another exemplary configuration of the touch panel in the embodiment.

FIG. 13 is a cross-sectional view illustrating another exemplary configuration of the touch panel in the third variant.

### DESCRIPTION OF THE REFERENCE CHARACTERS

10 input device
12, 52 touch panel
12a, 13a protective film
12b, 13b transparent conductive film
12c, 13c glass substrate
14, 54 liquid crystal display device
14a liquid crystal panel
14as, 54as display surface
14c peripheral member
15 cylindrical housing
T1 to T4 terminal
Spos position signal
Sop operation signal
Sd display signal
Sst status signal

### BEST MODE FOR CARRYING OUT THE INVENTION

Hereinafter, an embodiment of the present invention will be described with reference to the accompanying drawings.

FIG. 1 is a block diagram schematically illustrating the configuration of an input device according to the embodiment of the present invention. The input device 10 includes a transparent domical touch panel 12, a liquid crystal display device 14 disposed on the back side of the panel, a position detection processing portion 20, and a data processing portion 30, and the input device 10 is used as an input operation means for predetermined electronic equipment.

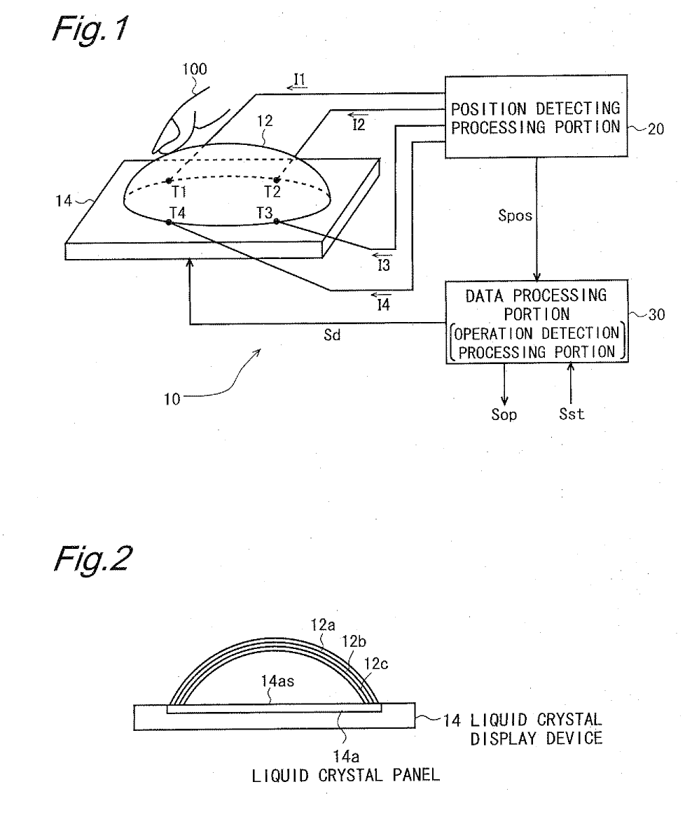

The touch panel 12 includes four electrodes T1 to T4 around its circumference, and the electrodes T1 to T4 are electrically connected to the position detection processing portion 20 via predetermined signal lines. FIG. 2 is a cross-sectional view illustrating the configuration of a substantial portion of the input device 10, including the touch panel 12. The touch panel 12 is of a capacitance type, and is configured such that a transparent conductive film 12b and a protective film 12a are sequentially layered on a glass substrate 12c provided in the form of a dome, as shown in FIG. 2, and the electrodes T1 to T4 are connected to the transparent conductive film 12b. The glass substrate 12c is made up of, for example, soda glass, borosilicate glass, or heat-resistant glass, and has a thickness of about 1 mm to 3 mm. The transparent conductive film 12b is made up of a film of, for example, ITO (indium tin oxide), IZO (indium zinc oxide), or SnO₂ (tin dioxide) which is formed to a thickness of 10 nm to 30 nm on the glass substrate 12c via sputtering, and has a surface resistance of about 500Ω/□ to 2Ω/□. The protective film 12a is made up of a film of an insulating material, such as SiO₂ (silicon dioxide) or SiNx (silicon nitride), which is formed on the transparent conductive film 12b via sputtering or CVD (chemical vapor deposition), and has a thickness of about 100 nm to 1 μm. In addition, the protective film 12b may be formed, for example, via dipping or spin coating, and in such a case, its thickness is greater than in the case of being formed via sputtering or CVD.

The position detection processing portion 20 applies predetermined voltage (typically, AC voltage) to the terminals T1 to T4 of the touch panel 12, and detects current flowing via each of the terminals T1 to T4 to calculate the coordinates that indicate the position of an operation point based on the value Tj (j=1 to 4) of the detected current flowing via each terminal Tj before outputting a signal indicating the coordinates as a position signal Spos. Specifically, when the operator touches (the protective film 12a of) the touch panel 12 with his/her finger 106, the operation point and the human body are capacitively coupled, changing the impedance of the touch panel 12 as viewed from the terminal Tj, so that the current flowing from the terminal Tj to the operator via the transparent conductive film 12b and the protective film 12a of the touch panel 12 and the finger 100 changes in accordance with the change of the impedance. For example, when the finger 100 of the operator is touching the touch panel 12, the value of the current flowing via the terminal T7 depends on the position of the point touched by the finger 100 on the touch panel 12 and the coupling capacitance between the touch panel 12 and the human body. The coupling capacitance depends on the distance between the touch panel 12 and the human body or the area of the touch panel 12 that is in contact with the human body, and therefore by deeming any operation to have been performed when the coupling capacitance with respect to the touch panel 12 is greater than a predetermined value, it becomes possible to determine whether any operation has been performed based on the value T j of the detected current flowing via the terminal Tj, and if any operation has been performed, it is possible to calculate the coordinates that indicate the position of the operation point at the time of the operation.

Here, the protective film 12a side surface (in the figure, the top surface) of the touch panel 12 functions as an input surface for receiving input operations, and the touched point when the touch panel 12 is determined to have been operated serves as an operation point on the input surface. Specifically, when the operator's finger 100 causes capacitive coupling greater than a predetermined value on the input surface of the touch panel 12, the point touched with the finger 100 is selected as the operation point from among points within the input surface that correspond to their respective inputtable operations. The position detection processing portion 20 outputs a position signal Spos indicating the coordinates of the operation point (the position within the input surface). Such processing by the position detection processing portion 20 is based on a well-known technique related to the capacitance-type touch panel, and therefore any detailed description thereof will be omitted. Note that in the present embodiment, the four terminals T1 to T4 are provided to the touch panel 12, but the number of terminals for applying voltage to the touch panel 12 may be three or more.

The liquid crystal display device 14 includes a liquid crystal panel 14a having a display surface 14as disposed to face the back side of the touch panel 12 (the glass substrate 12c side surface, i.e., the bottom surface in the figure), and displays an operation screen, including graphics, symbols, etc., which correspond to their respective inputtable operations, based on a display signal Sd supplied from the data processing portion 30. Since the touch panel 12 is transparent, the operator can perform input operations while viewing such a display on the liquid crystal panel 14a. Here, characters are also included in the “symbols” on the liquid crystal panel 14a or suchlike that are presented to the operator via the touch panel 12, i.e., the “symbols” provided as elements of the operation screen.

The data processing portion 30 functions as an operation detection processing portion for allowing the liquid crystal display device 14 to display graphics, symbols, etc., which correspond to their respective inputtable operations, and detecting input operations via the touch panel 12. Specifically, the data processing portion 30 receives a status signal Sst indicating the function, mode, or suchlike that is selected in the electronic equipment in which the input device 10 is used (hereinafter, referred to as the “present electronic equipment”) and the data processing portion 30 generates and supplies a display signal Sd to the liquid crystal display device 14 based on the status signal Sst. In parallel with this, the data processing portion 30 determines the content of an input operation by the finger 100 pressing the touch panel 12, i.e., the content of an operation corresponding to the operation point on the input surface, based on the position signal Spos from the position detection processing portion 20 and the status signal Sst from the present electronic equipment, and the data processing portion 30 outputs a signal indicating the content of the operation as an operation signal Sop. Note that a data processing device included in the present electronic equipment may also function as the data processing portion 30. In such a case, the operation signal Sop and the status signal Sst are processed as internal data of the data processing device.

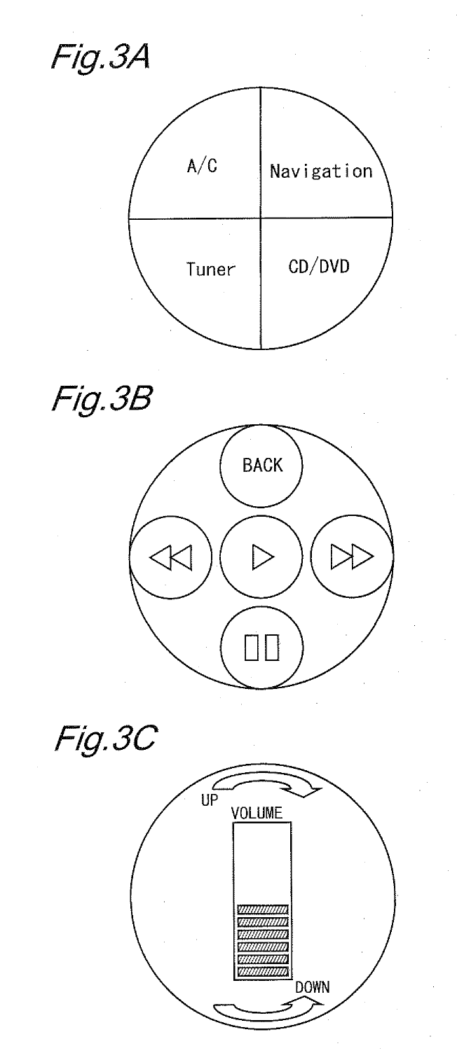

The input device 10 according to the present embodiment is configured to be able to deal with a plurality of functions or modes of the present electronic equipment, and can switch the content of a display on the liquid crystal panel 14a, i.e., the operation screen, in accordance with selection of the function or mode of the present electronic equipment. FIGS. 3A to 3C are diagrams for describing such switching of the operation screen.

In the examples shown in FIGS. 5A to 3C, the input device 10 is used for input operations on in-car electronic equipment having a plurality of functions, such as car navigation, CD (compact disc)/DVD playback, and radiobroadcast reception. FIG. 3A is a top view of the touch panel 12 in which a function selection screen, which is an operation screen for selecting the function to be used in such electronic equipment, is being displayed on the liquid crystal panel 14a. FIG. 3B is a top view of the touch panel 12 in which an operation screen (a screen for virtual button operation), for example, when CD/DVD playback was selected by operation on the function selection screen, is being displayed on the liquid crystal panel 14a. FIG. 3C is a top view of the touch panel 12 in which an operation screen (a screen for operating a virtual volume control dial) when switching to volume control mode was performed after selecting some function by operating the function selection screen, is being displayed on the liquid crystal panel 14a.

As described above, the data processing portion 30 receives the status signal Sst from the present electronic equipment, and causes the liquid crystal panel 14a to display graphics, symbols, etc., which correspond to inputtable operations for the function or mode specified by the status signal Sst. As a result, the operation screen presented to the operator via the transparent touch panel 12, i.e., the display on the input surface, is switched in accordance with the function or mode selected in the present electronic equipment as shown in FIGS. 3A to 3C. Such an operation screen allows the operator to confirm the function or mode currently being selected in the present electronic equipment, currently inputtable operations, and positions serving as operation points for the inputtable operations. Note that in the case of the operation screen as shown in FIG. 3A or 3B, the input operation via the touch panel 12 is performed by the operator pressing a point on the input surface (the position serving as an operation point) with his/her finger, whereas in the case of the operation screen as shown in FIG. 3C, the input operation is performed by the operator sliding the finger while pressing the input surface.

In typical usage forms (FIGS. 3A and 3B) of the input device 10 according to the present embodiment, the operator recognizes in advance the positions within the input surface that correspond to inputtable operations for the function or mode selected in the present electronic equipment, via the operation screen displayed on the liquid crystal panel 14a. Thereafter, for example, when operating the present electronic equipment while driving a car, the operator gently touches the touch panel 12 with his/her hand or finger without viewing the input surface of the touch panel 12, thereby perceiving the area of the input surface, and presses the position within the input surface that corresponds to a desired operation with the finger. In the present embodiment, the touch panel 12 is curved (domical) but flat outside the periphery of the input surface, and therefore it is possible to find by touch the position within the input surface that corresponds to the desired operation.

According to the present embodiment, the touch panel 12 is domical, as described above, so that the operator can recognize by touch the position within the input surface that corresponds to a desired operation, before pressing the position with his/her finger, for example, to perform the desired operation without viewing the input surface. Therefore, the input device according to the present embodiment is useful for example, as an input operation means for in-car electronic equipment or suchlike.

Also, in the present embodiment, the operation screen presented to the operator via the touch panel 12 is switched in accordance with selection of a function or mode of the present electronic equipment, and therefore it is possible to allow operations corresponding to a number of functions or modes to concentrate on one input surface. Furthermore, the inputtable operations, and the positions within the input surface that correspond to the operations (the positions serving as operation points) can be visually confirmed on each occasion with ease via the touch panel 12.

Unlike in the case of, for example, artificially simulating a trackball, as in the touch sensor-type coordinates input device described in Patent Document 4 (Japanese Laid-Open Patent Publication No. 2004-94450), in the present embodiment, for example, where the content of an operation is determined based on the position of the operation point on the input surface of the touch panel and the display surface is disposed on the back side of the touch panel, the transparency of the touch panel is important. On the other hand, in the case of the resistive film system as employed by a number of conventional touch panels, there arises a problem in ensuring the transparency when attempting to achieve a curved touch panel in the form of a dome or suchlike as in the present embodiment. Specifically, in the case of the resistive film system, for example, it is necessary to provide a predetermined gap between two transparent sheets, such as transparent resin films, having transparent electrodes formed thereon. Therefore, in order to achieve a curved touch panel, it is necessary to place more spacers between the two transparent sheets compared to the case of achieving flat touch panels. This renders the input surface less attractive in appearance, and reduces visibility of the operation screen, including graphics, symbols, etc., displayed on the display surface on the back side of the touch panel. Also, in the case of the electromagnetic induction system, when the panel is touched by a specialized pen capable of generating magnetic fields, the touched position is detected based on the magnetic fields, and therefore it is difficult to achieve a curved touch panel. Furthermore, in the case of the ultrasonic or infrared system also, it is difficult to achieve a curved touch panel in view of ultrasonic or infrared propagation characteristics (for example, linearity).

On the other hand, in the present embodiment, the capacitance-type touch panel 12 is used, and therefore there is no need to form any gap within the touch panel, which ensures satisfactory transparency even if the touch panel is domical as shown in FIG. 1, for example.

<2. Variants>

Variants of the above embodiment will be described below. Note that in each variant, elements that are the same as or correspond to the elements in the above embodiment are denoted by the same reference characters, and any detailed descriptions thereof will be omitted.

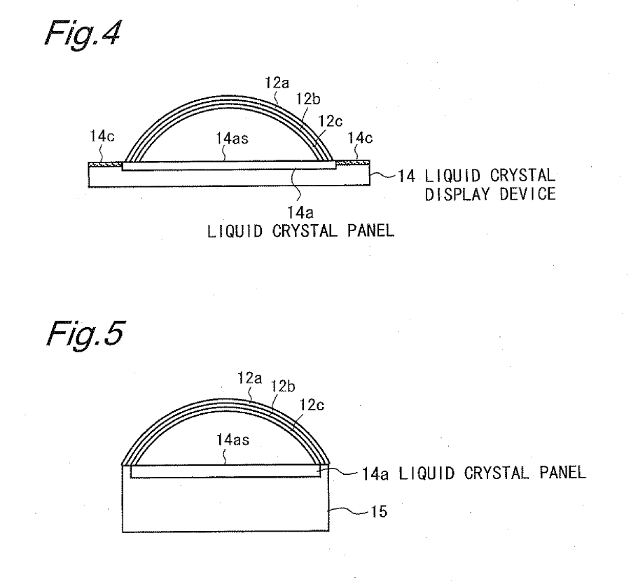

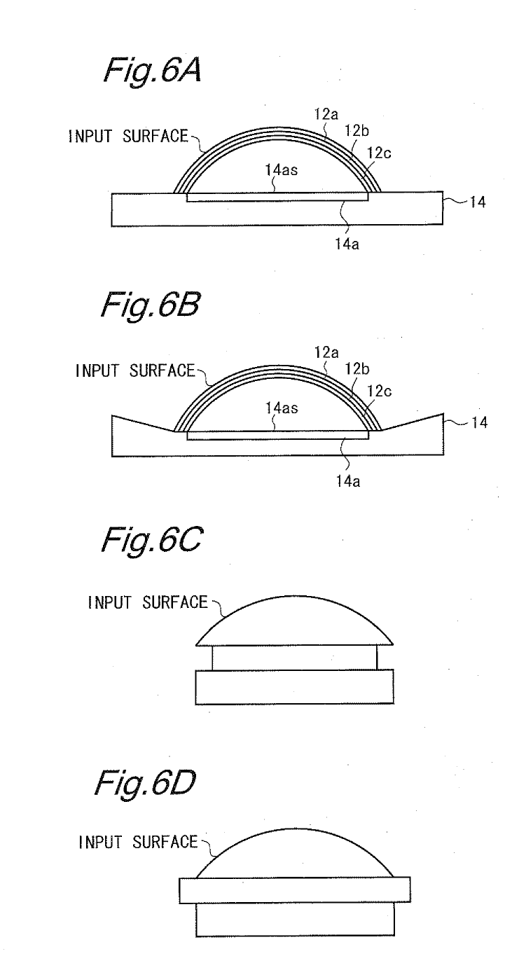

In the above embodiment, the operator gently touches the surface of the touch panel 12, i.e., the input surface for operation, with his/her hand or finger to recognize the boundary between the area of the input surface and its peripheral area, thereby finding the position within the input surface that corresponds to a desired operation (the position serving as an operation point) before pressing the position with the finger or suchlike. In this manner, the operator performs a desired input operation without viewing the input surface. Accordingly, in order to perform an input operation without viewing the input surface, the input surface of the touch panel 12 needs to be domical, and furthermore, the boundary between the input surface and its peripheral area needs to be recognizable by touch. Therefore, as shown in FIG. 4, the input surface of the touch panel 12 has preferably attached around its periphery a peripheral member 14c, which is a member providing a feel different from that provided by the input surface (e.g., a member with rough surface). In addition, a cylindrical housing 15 containing the liquid crystal panel 14a may be used such that the circumference around the circular top surface of the cylindrical housing 15 matches the circumference of the touch panel 12, as shown in FIG. 5. With this configuration, surfaces inside and outside the bounds of the input surface are differently curved, thereby making it possible to recognize by touch the boundary between the input surface and its peripheral area. Furthermore, in order to allow the boundary between the input surface and its peripheral area to be recognized by touch, the following configurations may be employed regardless of whether the peripheral member is of the same type as or a different type from the input surface. Specifically, the peripheral area of the input surface may be flat as shown in the cross-sectional view in FIG. 6A, and also, the peripheral area of the input surface may have a bowl-like surface (a surface inclined downward from the circumference to the touch panel at the center), as shown in the cross-sectional view in FIG. 6B, an irregular surface on the back side dented inward from the circumference of the input surface, as shown in the side view in FIG. 6C, or a flat surface projecting outward from the circumference of the input surface, as shown in the side view in FIG. 6D.

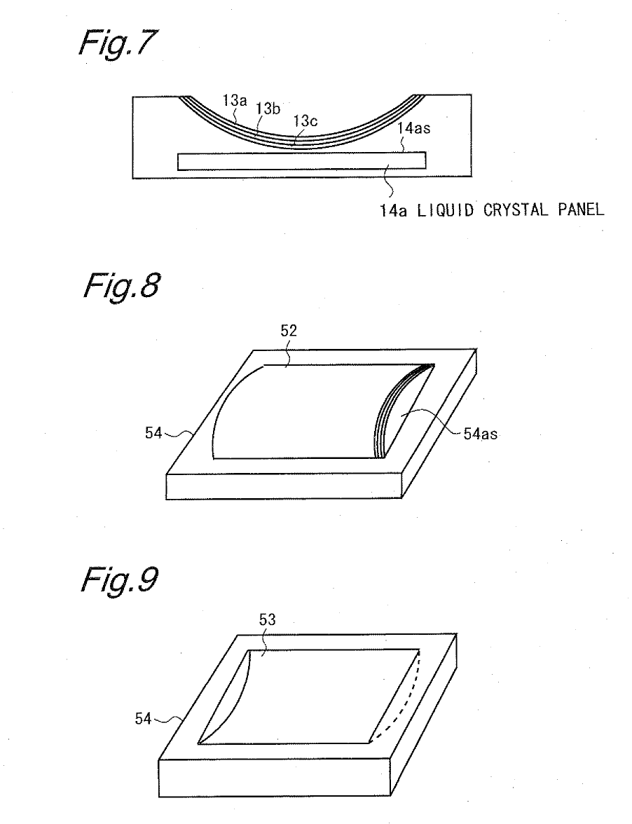

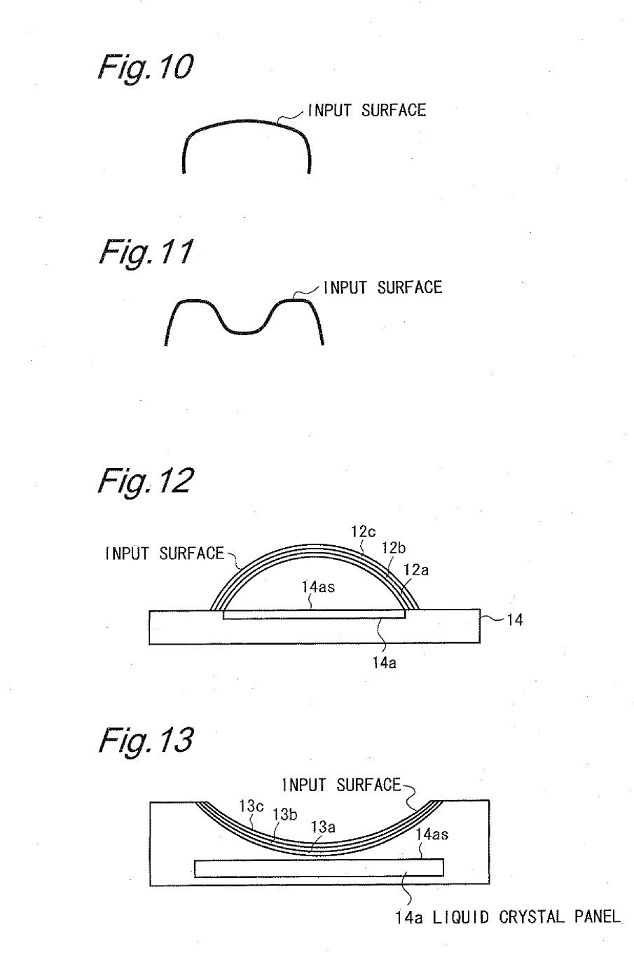

In the above embodiment, the touch panel 12 is domically configured (more generally, convexly curved) in order to allow the position within the input surface to be recognized by touch, but the shape of the touch panel is not limited to a dome or a convex curve so long as the touch panel is curved (more precisely, the input surface may be curved). For example, a touch panel having a transparent conductive film 13b and a protective film 13a sequentially layered on a glass substrate 13c may be provided in the shape of a bowl (more generally, a concavely-curved shape), as shown in FIG. 7. In addition, a touch panel 52 may be provided in the shape of an arch, and disposed on a liquid crystal display device 54 having a rectangular display surface 54as, as shown in FIG. 8. In the case where the input device uses such an arched touch panel, a concavely-arched touch panel 53 as shown in FIG. 9 (a cross-sectional view of such a panel is similar to that in FIG. 7) may be used, instead of using the convexly-arched touch panel 52 as shown in FIG. 8. Furthermore, the input surface of the touch panel may have a pseudo-cylindrical shape with a convex top surface, as shown in FIG. 10, or it may have a convex shape recessed at the center, as shown in FIG. 11.

In the above embodiment and variants (FIGS. 2 to 9) the touch panel has the transparent conductive film and the protective film sequentially layered on the glass substrate, but the layering order of the touch panel may be reversed. For example, in the case of the touch panel 12 shown in FIG. 2, the transparent conductive film 12b and the protective film 12a are sequentially layered on the domical glass substrate 12c, but instead of this, the glass substrate 12c, the transparent conductive film 12b, and the protective film 12a may be sequentially layered in order from the input surface side to the back surface side, as shown in FIG. 12. Also, in the case of the bowl-shaped (concavely-curved) touch panel, the glass substrate 13c, the transparent conductive film 13b, and the protective film 13a may be sequentially layered in order from the input surface side to the back surface side, as shown in FIG. 13. In the case of so reversing the layering order of the touch panel, the glass substrate side surface serves as the input surface, which improves touch panel durability because the glass substrate is generally more durable than the protective film. In this case, however, touch panel sensitivity and SN ratio decrease. Therefore, typical touch panels employ the structure in which the conductive film is layered on the glass substrate (the structure in which the protective film side surface serves as the input surface) as in the above embodiment.

In the above embodiment and variants, the liquid crystal display device 14, 54, is used to present to the operator the operation screen including graphics, symbols, etc., which correspond to inputtable operations, but instead of using this, other display devices capable of electronically or mechanically changing the content of a display may be used. Also, in the above embodiment and variants, the edge of the display surface 14as, 54as, of the liquid crystal display device generally matches the edge of the touch panel 12, 52, so that the display surface 14as, 54as, generally matches the input surface of the touch panel 12, 52, when viewed in a top view (see, for example, FIGS. 2 to 5, 7, and 8), but the display surface does not always have to match the input surface, and it may be larger or smaller than the input surface. Furthermore, the content of a display on the input surface may be fixed depending on applications, and for example, instead of disposing the liquid crystal panel 14a of the liquid crystal display device 14 on the back side of the touch panel 12, a display plate having printed thereon graphics, symbols, etc., which correspond to inputtable operations, may be disposed on the back side of the touch panel 12.

### INDUSTRIAL APPLICABILITY

The present invention is applicable to input devices for operating electronic equipment or suchlike, and is particularly suitable for input devices in which the touch panel is used.

1. An input device using a touch panel, comprising:
a transparent capacitance-type touch panel having a curved input surface; and
a display portion having a display surface disposed on the back side of the touch panel.

2. The input device according to claim 1, wherein the input surface is in the shape of a dome, a bowl, or an arch.

3. The input device according to claim 1, wherein the input surface has a flat member disposed around its periphery.

4. The input device according to claim 1, wherein the input surface has a curved member disposed around its periphery, the curved member being differently curved from the input surface.

5. The input device according to claim 1, wherein the input surface has a member disposed around its periphery, the member providing a different feel from that provided by the input surface.

6. The input device according to claim 1, wherein the display portion variably displays, on the display surface, graphics and/or symbols corresponding to operations that can be inputted via the touch panel.

7. The input device according to claim 6, wherein the display portion includes a liquid crystal panel for displaying the graphics and/or symbols.

8. The input device according to claim 6, further comprising:
a position detection processing portion for outputting a position signal indicating a position of an operation point selected on the input surface for an input operation via the touch panel; and
an operation detection processing portion for outputting an operation signal indicating the content of the input operation via the touch panel,
wherein the touch panel includes at least three terminals at different positions around its circumference,
wherein the position detection processing portion supplies predetermined voltage to the three terminals, detects current flowing via each terminal, and generates the position signal based on a value of the detected current, and
wherein the operation detection processing portion receives a predetermined status signal, causes the display surface to display the graphics and/or symbols based on the status signal, and generates as the operation signal a signal indicating the content of an operation corresponding to the operation point, based on the position signal and the status signal.
